(19) United States
(12) Patent Application Publication
(10) Pub. No.: US 2023/0160317 A1
(43) Pub. Date: May 25, 2023

(54) TURBO GENERATOR WITH SEPARABLE SHROUD

(71) Applicant: Enviro Power, Inc., South Windsor, CT (US)

(72) Inventors: Michael A. Cocuzza, Glastonbury, CT (US); Graham H. Steen, Glastonbury, CT (US)

(21) Appl. No.: 17/993,239

(22) Filed: Nov. 23, 2022

Related U.S. Application Data
(60) Provisional application No. 63/282,868, filed on Nov. 24, 2021.

(51) Int. Cl. F01D 15/10; H02K 7/18

(52) U.S. Cl. CPC F01D 15/10; H02K 7/1823; F05D 2220/76; F05D 2230/51; F05D 2230/64

(57) ABSTRACT

A turbo generator is configured to allow the turbine to be assembled to the generator, calibrated, and then shipped, stored, and installed as a generator/turbine unit. The turbine shroud is formed as a separate component from a turbine casing that defines an inlet volute and inlet and outlet connections to working fluid conduits of a Rankine cycle system. The inlet and outlet on the turbine casing can be permanently connected to the associated working fluid conduits by welding or other low-cost, sealed, permanent connection, and the generator/turbine assembly can be separated from the turbine casing while the turbine casing is permanently connected to the working fluid conduits.

### BACKGROUND

This disclosure relates to Rankine cycle turbine generator systems and more particularly to a Rankine cycle turbine generator configured to reduce the cost and complexity of manufacture and repair.

Turbines for driving a generator in a Rankine cycle system require precision assembly to ensure efficient and reliable long-term operation. The turbine and generator may operate at very high rotational speeds exceeding 80,000 rpm, which subject the bearings supporting the generator shaft and turbine wheel to high forces. The turbine wheel is subjected thermal stress from large temperature changes, in addition to the stresses from very high rotational speeds. The generator and/or turbine may require service during the useful life of the Rankine cycle system.

There is a need for a turbo generator for use in a Rankine cycle system where the turbo generator is configured to reduce the cost and complexity of manufacture and repair.

There is a need for a turbo generator for use in a Rankine cycle system that can be serviced in the field without the need for service personnel with highly specialized skills, training, and equipment.

### SUMMARY OF THE INVENTION

A turbo generator is configured to allow the turbine to be assembled to the generator, calibrated, and then shipped, stored, and installed as a generator/turbine unit. According to aspects of the disclosure, the turbine shroud is formed as a separate component from a turbine casing that defines an inlet volute and inlet and outlet connections to working fluid conduits of the Rankine cycle system. Separating the shroud from the turbine casing allows the turbine to be assembled to the generator and tested before the generator/turbine assembly is connected to the turbine casing. According to aspects of the disclosure, the inlet and outlet on the turbine casing can be permanently connected to the associated working fluid conduits by welding or other low-cost, sealed, permanent connection, and the generator/turbine assembly can be separated from the turbine casing while the turbine casing is permanently connected to the working fluid conduits.

A disclosed embodiment of a turbine driven generator comprises a generator having a shaft, a generator housing and a generator end plate including a seal surrounding the shaft, the generator shaft extending along an axis of rotation through the generator end plate and coupled to components of the generator that generate electrical current when the shaft is rotated. A turbine wheel is secured to the shaft so the turbine wheel and shaft rotate together, the turbine wheel including a plurality of blades extending from a body of the turbine wheel to blade tips. A nozzle ring including a plurality of vanes surrounds a periphery of the turbine wheel. A turbine shroud is secured to the generator end plate with the nozzle ring axially between the turbine shroud and generator end plate. The turbine shroud including a shroud inside surface defining a working clearance between the blade tips and the shroud. The turbine shroud defines a turbine exhaust outlet surrounding an axis of rotation of the turbine wheel and shaft. A turbine casing includes an inlet opening for vapor phase working fluid and an outlet for vapor phase working fluid passing through the turbine exhaust outlet. The turbine casing at least partially defining an inlet volute directing vapor phase working fluid through the vanes of the nozzle ring and onto the turbine wheel where energy is transferred from the vapor phase working fluid to the turbine wheel. The turbine shroud is separate from the turbine casing and the turbine shroud and turbine casing are each independently attached to the generator end plate and the generator end plate can be separated from the turbine casing while the turbine shroud remains connected to the generator end plate.

The nozzle ring may be a separate component trapped between a periphery of the turbine shroud and the generator end plate. Alternatively, the nozzle ring may be formed as an integral part of the generator end plate or as an integral part of the shroud.

### BRIEF DESCRIPTION OF THE DRAWINGS

FIG. 1 is a longitudinal sectional view through a turbine-driven generator showing the inlet volute separated from the generator end plate, turbine wheel, nozzle ring and shroud according to aspects of the disclosure;

FIG. 2 is an exploded perspective view of the components of the turbine assembly of the turbine-driven generator according to aspects of the disclosure; and

FIG. 3 is a longitudinal sectional view through the generator end plate, turbine wheel, nozzle ring, and shroud, with the inlet volute and exhaust diffuser mounted to the generator end plate according to aspects of the disclosure;

FIG. 4 is a longitudinal sectional view through a second embodiment of a turbine-driven generator according to aspects of the disclosure;

FIG. 5 is an exploded perspective view of the turbine-driven generator of FIG. 4;

FIG. 6, is a longitudinal sectional view through a third embodiment of a turbine driven generator according to aspects of the disclosure; and

FIG. 7 is an exploded perspective view of the turbine-driven generator of FIG. 6.

### DETAILED DESCRIPTION

Various embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details. An aspect or an advantage described in conjunction with a particular embodiment is not necessarily limited to that embodiment and can be practiced in any other embodiments even if not so illustrated or if not so described explicitly. Repetitive description of same or similar functionalities of like components described in prior embodiments is omitted for sake of brevity.

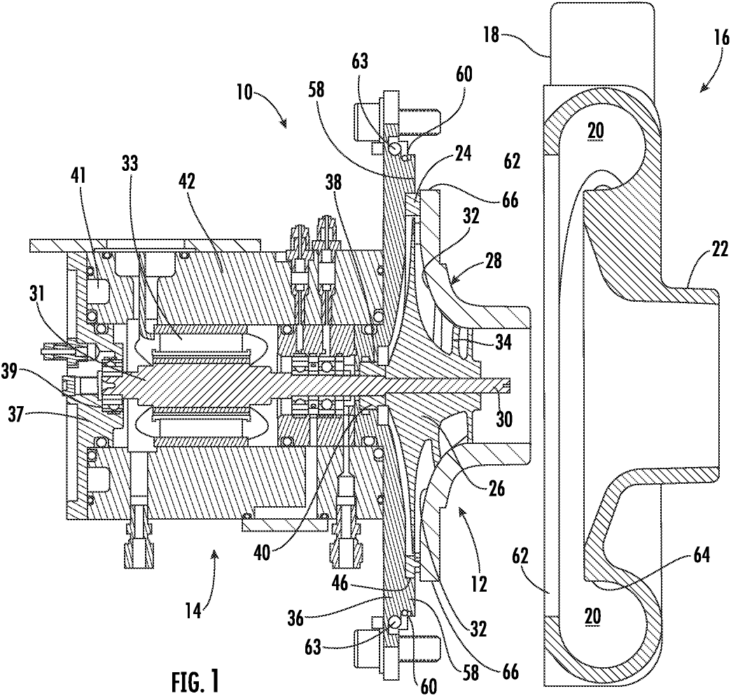

With reference to FIG. 1, a turbo generator 10 is configured to reduce the cost and complexity of manufacture and also to reduce the cost and complexity of maintenance should service be required. A radial inflow turbine assembly 12 is arranged to drive an electric generator 14 which may be an induction generator or synchronous generator. The design and operation of induction and synchronous generators is well-understood and will not be discussed in detail. The turbo generator 10 includes a generator 14, a turbine assembly 12 and a turbine casing 16. The turbine casing 16 includes an inlet 18, an inlet volute 20 and a turbine exhaust outlet 22. The inlet 18 and inlet volute 20 receive energetic vapor phase working fluid and direct the working fluid through a nozzle ring 24 to increase the velocity of the working fluid and orient the flow of working fluid in a specific trajectory toward a turbine wheel 26 as is known in the art. The working fluid may be water, organic refrigerant, or any other material compatible with the Rankine cycle. Energy is transferred from the working fluid to the turbine wheel 26, which is arranged to rotate a shaft 30 connected to a rotor 31 including magnets that generate electrical current when rotated relative to stator coils 33. A turbine shroud 28 includes an inside surface 32 spaced from the turbine wheel 26 so that the working fluid is directed through the blades 34 of the turbine 12. A working clearance is defined between tips of the blades 34 on the turbine wheel 26 and the inside surface 32 of the shroud 28. The working clearance is as small as possible while avoiding any contact between the turbine blades 34 and the inside surface 32 of the shroud 28. The working clearance between the turbine blades 34 and the inside surface 32 of the shroud 28 must take into account the dimensional tolerances of the turbine wheel 26 and shroud 28, dimensional tolerance of components positioning the turbine wheel 26 and shroud 28 relative to each other, and changes in the dimensions of the turbine wheel 26, shroud 28 and adjacent structures due to expansion and contraction as temperature of the turbine assembly 12 changes during operation of the turbo generator 10.

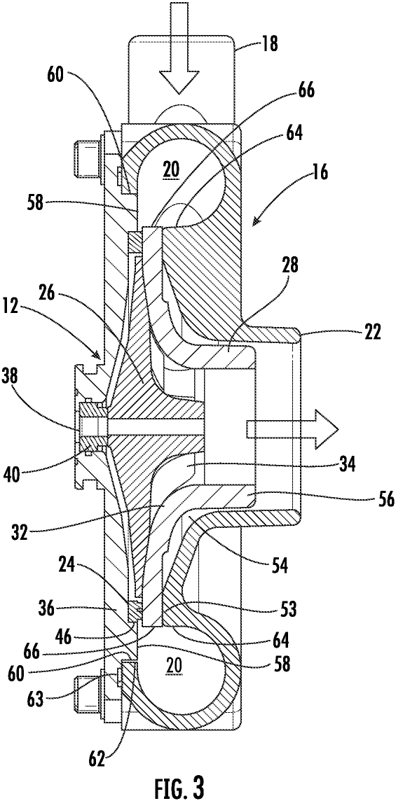

According to aspects of the disclosure, the turbine casing 16 includes an inflow volute 20 and outlet 22 but does not include the shroud 28, which is a separate component. The turbine casing 16 is configured to mount to a radially extended end plate 36 of the generator 14. The generator end plate 36 includes an opening 38 for a shaft 30 that extends from the turbine wheel 26 into the generator 14. The opening 38 in the generator end plate 36 includes a seal 40 to prevent working fluid from passing along the shaft 30 and into the generator body 42. The turbine wheel 26 is secured to the shaft 30 so that rotation of the turbine wheel 26 rotates the rotor 31 of the generator 14 resulting in a flow of electrical current. The construction and operation of shaft driven generators and alternators is well-understood and will not be discussed in detail here. A nozzle ring 24 includes vanes 44 that direct working fluid from the inflow volute 20 onto the turbine wheel 26 at an increased velocity and in a pre-determined angular orientation relative to blades 34 on the turbine wheel 26 as is known in the art. The generator end plate 36 defines a circular shoulder 46 within which the nozzle ring 24 is mounted, with a base side of the nozzle ring 24 against an outside surface of the generator end plate 36 and a radially outer side of the nozzle ring 24 against the circular shoulder 46 as shown in FIGS. 1 and 3.

According to aspects of the disclosure, the shroud 28 is separate from the turbine casing 16 and is secured to the generator end plate 36 by fasteners 48 that extend through the nozzle ring 24 into the end plate 36. Making the shroud 28 separate from the turbine casing 16 and mounting the shroud 28 and nozzle ring 24 to the generator end plate 36 allow the generator 14, along with its end plate 36, turbine wheel 26, nozzle ring 24 and shroud 28 (the turbine assembly 12) to be separated from the turbine casing 16 which includes the inlet 18, inflow volute 20, and integrally formed outlet 22 as shown in FIG. 1. The inlet 18 to the inflow volute 20 and the outlet 22 can be permanently attached to the associated working fluid conduits by welding or other permanent connection. The generator 14 and turbine assembly 12 can be separated from the turbine casing 16 as shown in FIG. 1 without disconnecting the inlet 18 and outlet 22 from the working fluid conduits, should service of the generator 14 or turbine assembly 12 be necessary.

Separating the shroud 28 from the turbine casing 16 allows the generator 14 to be assembled to the turbine assembly 12 to form a turbo-generator 10 that can be handled as a unit. In the illustrated embodiment, the turbine assembly 12 is built on the generator end plate 36 with the axial position of the turbine wheel 26 defined by a shoulder on the shaft 30. The shroud 28 is spaced apart from the generator end plate 36 by the nozzle ring 24, with the axial position of the shroud inside surface 32 relative to the tips of the turbine wheel blades 34 defining the working clearance. Together, the generator end plate 36, nozzle ring 24, and shroud 28 define a chamber surrounding the turbine wheel 26. In some embodiments, one or more annular shims (not shown) may be arranged between the nozzle ring 24 and the generator end plate 36 to adjust the axial position of the shroud 26 to calibrate the working clearance between an inside surface 32 of the shroud 26 and the tips of the blades 34 of the turbine wheel 26. With the shroud 28 securely mounted to the generator end plate 36, the working clearance of the turbine assembly 12 is fixed and is not disturbed when the generator/turbine assembly is handled as a unit as shown in FIG. 1.

In the disclosed Rankine cycle turbine generator system, the fluid flow path for working fluid passing through the turbine is closed and sealed, so the connections between working fluid conduits and the inlet 18 and outlet 22 on the turbine casing 16 must be hermetically sealed to prevent leakage of working fluid. The disclosed turbo generator 10 is configured to be separated from the turbine casing 16 without disturbing the position of the shroud 28 relative to the turbine wheel 26. Providing the turbine shroud 28 as a separate component from the turbine casing 16 allows the connections of working fluid conduits to the inlet 18 and outlet 22 to be permanent, welded connections. Welded connections are relatively inexpensive, sealed, and permanent. According to aspects of the disclosure, the inlet 18 and outlet 22 connections can be welded and inspected while the turbine casing 16 is separated from the generator 14 and turbine assembly 12 (the turbo-generator 10) as shown in FIG. 1. With the turbine casing 16 separated from the turbo-generator, heat from the welding process cannot distort the shroud 28 or other components of the turbine assembly 12. The generator 14 and turbine assembly 12 can be connected to the turbine casing 16 after the welded connections are made, cooled, and inspected. Further, the permanent connections of working fluid conduits to the inlet 18 and outlet 22 can remain in place while the turbo-generator 10 is separated from the turbine casing 16 to permit service of the generator 14 and/or turbine assembly 12. A replacement, pre-assembled and pre-calibrated turbo-generator 10 can be exchanged for a turbo-generator in need of service. The exchange of one turbo-generator 10 for another is relatively simple and does not require specialized skills or equipment.

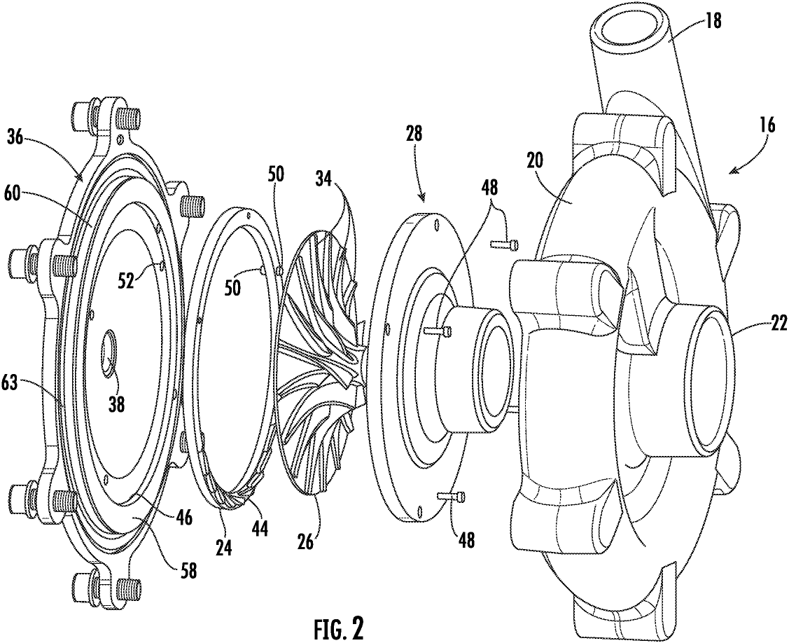

As shown in FIG. 2, the shroud 28 is mounted to the generator end plate 36 by fasteners 48 that pass through the shroud 28, the nozzle ring 24 and into threaded apertures in the generator end plate 36. The fasteners 48 ensure accurate location of the shroud 28 on the generator end plate 36 concentric with the axis of rotation of the turbine wheel 26 and shaft 30. In some embodiments, the nozzle ring 24 may include protruding nubs or pins 50 that are received in corresponding detents 52 in the generator end plate 36 and shroud 28 to ensure accurate placement of the shroud 28 relative to the axis of rotation of the shaft 30 and turbine wheel 26. The shroud 28 must be positioned accurately relative to the turbine wheel 26 to allow the smallest possible working clearance between the inside surface 32 of the shroud and the tips of the blades 34 on the turbine wheel 26. The working clearance must allow for expansion and contraction of the turbine assembly components, and any increase in working clearance necessary to also accommodate inaccurate positioning of the shroud 28 would decrease the efficiency of the turbine. The generator end plate 36, nozzle ring 24, turbine wheel 26 and shroud 28 are all constructed of stainless steel and have substantially equal coefficients of expansion, so these components should all expand and contract at approximately the same rate, keeping temperature-related changes in dimensions to a minimum. Providing the shroud 28 as a separate component from the much larger and more massive turbine casing 16, allows the shroud 28 to heat and cool at a different rate relative to heating and cooling of the turbine casing 16. As shown in FIG. 3, when the generator end plate 36 is mounted to the turbine casing 16, the casing 16 and shroud 28 are in contact with each other at the periphery of the shroud 28, but are not coupled to each other by fasteners or other means, which allows the shroud 28 and casing 16 to expand and contract independently without exposing each other to thermal stresses. The annular joint 53 between the periphery of the shroud 28 and the turbine casing 16 is formed by two planar surfaces clamped together when the turbine casing 16 is mounted to the generator end plate 36. In a disclosed embodiment, this connection 53 is not sealed since leakage of working fluid from joint 53 remains contained within turbine casing 16. As can be seen in FIG. 3, when the generator end plate 36 is mounted to the turbine casing 16, an annular space 54 is defined between the turbine exhaust outlet 56 on the shroud 16 and the exhaust outlet 22 on the turbine casing 16. During operation of the turbo generator 10, vapor phase working fluid leaving the shroud 28 will fill the space 54 between an outside surface of the shroud 28 and an inside surface of the turbine casing 16. Exposing both the inside and outside surfaces of the shroud 28 to heating from contact with vapor phase working fluid leaving the turbine should allow the shroud 28 to heat more uniformly and reduce thermal stresses within the shroud 28. It will be apparent to those skilled in the art that a uniformly heated shroud 28 will experience reduced thermal distortion and this should permit a reduced working clearance between the shroud 28 and the turbine blades 34.

FIG. 3 illustrates the turbine assembly 12 coupled to the turbine casing 16 and omits the generator 14 for ease of reference. According to aspects of the disclosure, it is not possible to separate the turbine assembly 12 from the generator 14, which are constructed to be assembled and handled as a generator/turbine assembly (turbo-generator 10) as shown in FIG. 1. The generator shaft 30 is supported on bearings in the generator 14, and the generator shaft 30 in turn supports the turbine wheel 26 in a pre-determined axial position. Further, the generator end plate 36 defines part of the chamber within which the turbine wheel 26 rotates. The shroud 28 can only be accurately positioned relative to the turbine wheel 26 after the turbine wheel 26 is secured to the generator shaft 30. The generator 14 includes a second, rear end plate 37 that connects to an end of the generator body 42 and includes a bearing 39 supporting one end of the generator shaft 30. In one embodiment, the generator body 42, end plate 36 and second end plate 37 cooperatively define coolant channels 41 through which coolant can be circulated to remove heat from the generator 14. The generator body 42, end plate 36 and second end plate 39 include seals to contain coolant in the coolant channels 41 and separate the coolant channels 41 from the “dry” area at the center of the generator 14. According to aspects of the disclosure, the generator 14, including end plate 36 and second end plate 37 is assembled before attachment of the turbine wheel 26, nozzle ring 24 and shroud 28 to form the turbo-generator 10 shown in FIG. 1.

As shown in FIG. 3, the inlet volute 20 is defined by portions of the turbine casing 16, the periphery of the shroud 28, and an annular portion 58 of the generator end plate 36 radially between the nozzle ring 24 and the turbine casing 16. The generator end plate 36 defines an annular, outward facing shoulder 60 configured to mate with an inward facing rim 62 of a circular opening in the turbine casing 16. In a disclosed embodiment, the generator end plate 36 includes grooves that accommodate one or more annular seals 63 compressed between the end plate 36 and the turbine casing 16 to seal the connection between the end plate 36 and turbine casing 16 to contain vapor phase working fluid. The seals 63 may be axially compressed, radially compressed or may include both an axial seal and a radial seal. FIG. 1 illustrates annular glands and O-ring type seals, but other seal configurations are compatible with the disclosed turbo generator 10. Since the connections of the turbine casing inlet 18 and outlet 22 to conduits carrying working fluid are permanent, only one sealed connection is needed between the turbine casing 16 and the disclosed turbo-generator 10 is needed at the periphery of the generator end plate 36 and turbine casing 16. It is possible to replace the seals 63 or gaskets at this connection 60/62 whenever the turbo-generator 10 is separated from the turbine casing 16.

As shown in FIG. 2, the nozzle ring 24 has a base with an axial height equal to an axial height of the annular shoulder 46 on the generator end plate 36. Above the base, the nozzle ring 24 defines vanes 44 that direct vapor phase working fluid onto the turbine wheel 26 at a predetermined trajectory. Although vanes 44 are illustrated only on the lower portion of nozzle ring 24, it will be understood that the vanes extend about the entire circumference of the nozzle ring 24. As shown in FIG. 3, the configuration of the inlet volute 20, the generator end plate 36 and the nozzle ring 24 form a surface of uniform height to guide vapor phase working fluid toward and through the vanes 44 on the nozzle ring 24. The bottom surface of the shroud 28 sits on top of the vanes 44 to form an upper boundary of openings between the vanes 44, each of which has a flat top surface to support the shroud 28 relative to the generator end plate 36 and turbine wheel 26. The circumference of the inner rim 64 of the inlet volute 20 and outer circumference 66 of the shroud 28 are substantially identical and define an inner boundary of the inlet volute 20. The surfaces of the generator end plate 36, nozzle ring 24, shroud 28 and turbine casing 16 that define the inlet volute 20 are selected and arranged to form a smooth, uninterrupted surface for guiding vapor phase working fluid from the inlet 18 through the vanes 44 of the nozzle ring 24.

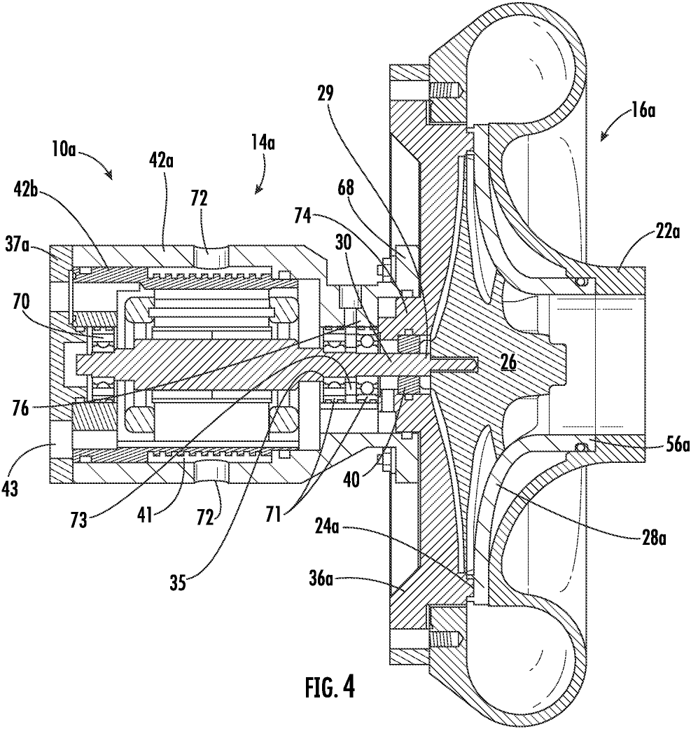

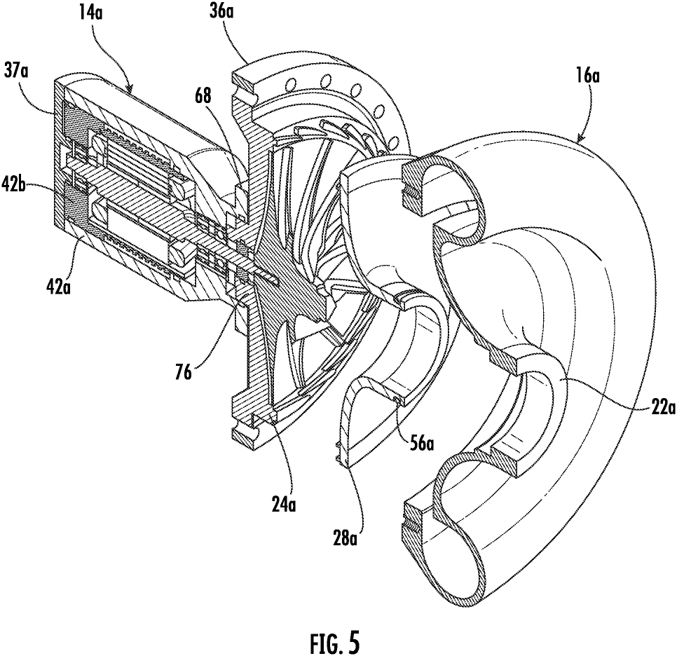

FIGS. 4 and 5 illustrate an alternative embodiment of a turbo-generator 10a and turbine casing 16a according to aspects of the disclosure. The basic structure and function of the turbo-generator 10a and turbine casing 16a of FIGS. 4 and 5 are similar to that of the turbo-generator 10 and turbine casing 16 described with regard to FIGS. 1-3 and will be discussed only to clarify differences between the embodiments. FIGS. 4 and 5 illustrate a turbo-generator 10a including a generator end plate 36a where the nozzle ring 24a is formed as an integral part of the generator end plate 36a. Reducing the number of parts in the generator 14a that determine the axial position of the generator shaft 30 and turbine wheel 26 relative to the generator end plate 36a allow the nozzle ring 24a to be formed integrally with the generator end plate 36a and eliminate the need for shims described with respect to the turbo-generator 10 described with respect to FIGS. 1-3. Outer and inner generator body parts 42a, 42b are sealed to each other to define a coolant channel 41a through which coolant is circulated to remove heat from the generator 14a. Outer generator body part 42a defines coolant openings 72 allowing coolant to circulate in the coolant channel 41. Coolant openings 72 are provided with durable, sealed connectors to coolant conduits (not shown). A forward end of generator body part 42a includes an outward projecting flange 68 by which the generator 14a is secured to the generator end plate 36a with the generator shaft 30 projecting through a shaft seal 40 supported by the generator end plate 36a. The generator shaft 30 is supported by a rear bearing 70 seated in inner generator body part 42b and forward bearings 71 seated in the forward end of the outer generator body part 42a. The forward end of the outer generator body part 42a receives and is sealed to a central projection 74 of the generator end plate 36a that extends axially to abut a shoulder 76 on the outer generator body part 42a that determines the position of the generator end plate 36a relative to the generator 14a when the generator 14a is secured to the generator end plate 36a. A generator rear end plate 37a closes the rear end of the generator housing 42a, 42b and biases inner generator housing part 42b into contact with a shoulder on generator outer housing part 42a, holding the outer generator part 42a and inner generator housing part 42b in a fixed, predetermined location relative to each other. The generator rear end plate 37a may define an outlet 43 for condensed vapor phase working fluid that has leaked into the central “dry” area of the generator casing 42a, 42b, e.g., the region defined between the generator end plate 36a, forward end of outer generator housing part 42a, inner generator housing part 42b and generator rear end plate 37a. Some vapor phase working fluid may get past the shaft seal 40 and condense within the central working region of the generator 14a and providing a drain 43 for this liquid phase working fluid will prevent it from accumulating within the generator and also allow the recovery of the working fluid for return to a working fluid reservoir (not shown).

In the turbo-generator 10a of FIGS. 4 and 5, the shroud 28a is secured to the generator end plate 36a by fasteners (not shown) extending through holes in the periphery of the shroud 28a in a manner similar to that shown with respect to the turbo-generator 10 illustrated in FIGS. 1-3. FIG. 5 illustrates the shroud 28a separated from the generator end plate 36a to show the nozzle ring 24a integrally formed as part of the generator end plate 36a. When manufactured and calibrated according to aspects of the disclosure, the turbo-generator 10a will include the shroud 28a mounted to the generator end plate 36a. The turbo-generator 10a is separable from the turbine casing 16a by removal of fasteners (not shown in FIGS. 4 and 5) from the periphery of the generator end plate 36a that secure the turbine casing 16a to the generator end plate. Although not shown in FIGS. 4 and 5, the turbine casing 16a includes an inlet in addition to the outlet 22a. As in the embodiment illustrated in FIGS. 1-3, the inlet and outlet 22a of the turbine casing 16a can be permanently joined to fluid conduits for energetic vapor phase working fluid provided from an evaporator (or other source) and for turbine exhaust from the outlet 22a to flow to a condenser. In the embodiment illustrated in FIGS. 4 and 5, the outlet 56a of the shroud 28a includes a gland and seal that mates with an inside surface of the turbine casing outlet 22a. The points of contact between the turbine casing 16a and the shroud 28a allow for relative movement between the shroud 28a and the turbine casing 16a, allowing the shroud 28a to expand and contract independently of the turbine casing 16a when heated during use and cooling when not being used. Allowing relative movement between the shroud 28a and the turbine casing 16a eliminates transfer of stress between the shroud 28a and the turbine casing 16a as the components heat up and cool down. According to aspects of the disclosure, the same material is used for the generator end plate 36a, turbine wheel 26a, shroud 28a and turbine casing 16a to reduce stress that might be caused by using different materials that have different rates of thermal expansion. If different materials are used, the materials may be selected to have similar rates of thermal expansion.

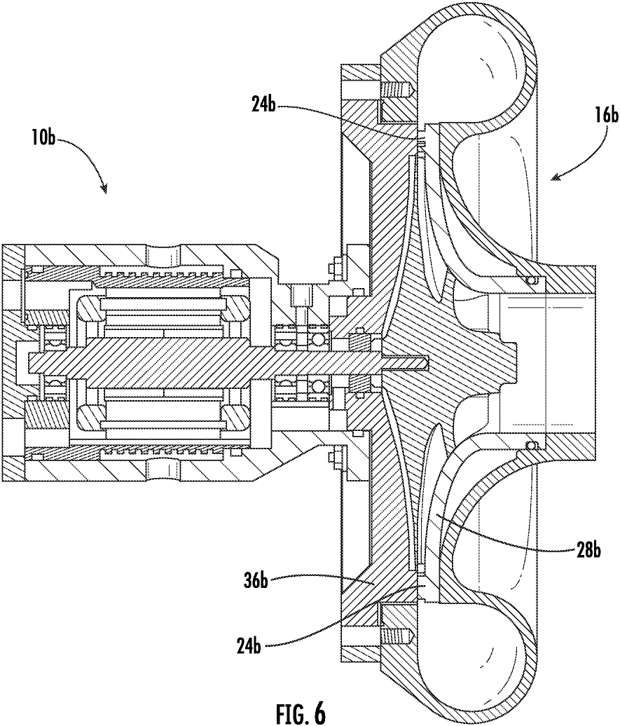

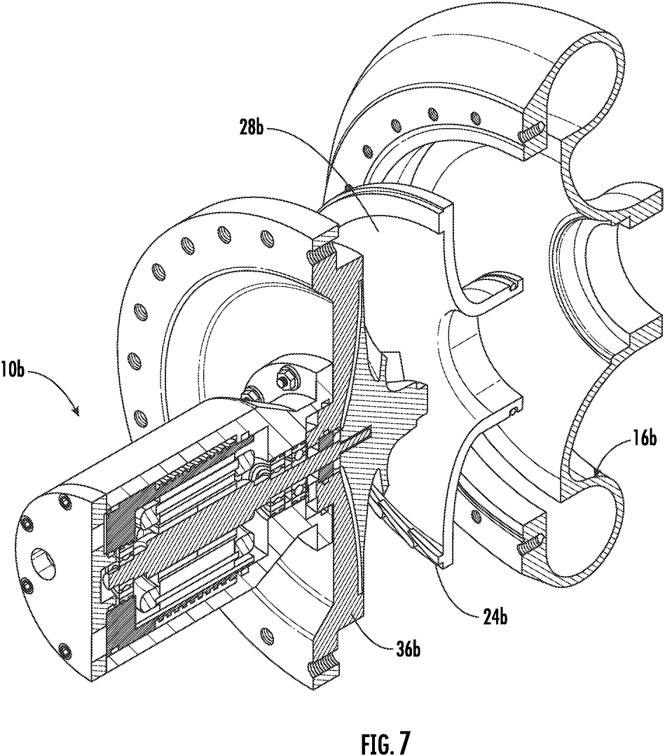

FIGS. 6 and 7 illustrate a further embodiment of a turbo-generator 10b and turbine casing 16b that is substantially identical to the turbo-generator 10a and turbine casing 16a illustrated in FIGS. 4 and 5. Turbo-generator 10b differs from turbo-generator 10a in that the nozzle ring 24b is formed as an integral part of the periphery of the shroud 28b and not generator end plate 36b. In all other respects, the turbo-generator 10b and turbine casing 16b of FIGS. 6 and 7 are identical to the turbo-generator 10a and turbine casing 16a of FIGS. 4 and 5. In FIG. 7, the vanes on the nozzle ring 24b are shown at the bottom of the figure and not at the top, but it will be understood that the nozzle ring 24b includes vanes extending around its entire circumference.

In the turbo-generator embodiments of FIGS. 4-7, determining the axial position of the generator shaft 30 and turbine wheel 26 relative to the generator end plate 36a, 36b will be described with reference to FIG. 4. The turbine wheel 26 is seated on a wheel shoulder 29 of the generator shaft 30, so the axial position of the turbine wheel 26 depends upon the axial position of the generator shaft 30. The generator shaft 30 includes a bearing shoulder 35 that seats against the forward bearings 71. The embodiments of FIGS. 4-7 employ an assembly of two forward bearings 71 separated by a spacer 73, although a single bearing with no spacer may also be used. The central projection 74 extending rearwardly from the generator end plate 36a defines a bearing stop surface against which the forward bearings 71 are seated. A biasing element between the rear bearing 70 and the rear end plate 37a biases the generator shaft 30 toward the generator end plate 36a, ensuring that the forward bearings 71 are in contact with the bearing stop surface on the central protrusion 74 of the generator end plate 36a. In this configuration, the axial position of the turbine wheel 26 is determined by the distance between the bearing shoulder 35 and wheel shoulder 29 on the generator shaft 30, the axial dimensions of the bearings 71 and spacer 73 and the distance between the bearing stop surface and outside surface of the generator end plate 36a. By precisely controlling these dimensions, the position of the turbine wheel 26 can be controlled within a small range that eliminates the need for a separate nozzle ring 24 and shims as described in the embodiment of FIGS. 1-3. Controlling the position of the turbine wheel 26 relative to the generator end plate 36a, 36b allows the nozzle ring 24a, 24b to be integrally formed with either the generator end plate 36a as shown in FIGS. 4 and 5 or with the shroud 28b as shown in FIGS. 6 and 7.

What is claimed:

1. A turbine driven generator comprising:
a generator having a shaft, a generator housing and a generator end plate including a seal surrounding the shaft, the generator shaft extending along an axis of rotation through the generator end plate and coupled to components of the generator that generate electrical current when the shaft is rotated;
a turbine wheel secured to the shaft so the turbine wheel and shaft rotate together, said turbine wheel including a plurality of blades extending from a body of the turbine wheel to blade tips;
a nozzle ring including a plurality of vanes surrounding a periphery of the turbine wheel;
a turbine shroud secured to the generator end plate with the nozzle ring axially between the generator end plate and the turbine shroud, said turbine shroud including a shroud inside surface defining a working clearance between the blade tips and the shroud, said turbine shroud defining a turbine exhaust outlet surrounding an axis of rotation of the turbine wheel and shaft;
a turbine casing including an inlet opening for vapor phase working fluid, an outlet for vapor phase working fluid passing through the turbine exhaust outlet, said turbine casing at least partially defining an inlet volute directing vapor phase working fluid through the vanes of the nozzle ring and onto the turbine wheel where energy is transferred from the vapor phase working fluid to the turbine wheel,
wherein said turbine shroud is separate from the turbine casing, the turbine shroud and turbine casing are each independently attached to the generator end plate and the generator end plate can be separated from the turbine casing while the turbine shroud remains connected to the generator end plate.

2. The turbine driven generator of claim 1, wherein portions of the turbine shroud, turbine casing and generator end plate define the inlet volute guiding vapor phase working fluid toward the nozzle ring.

3. The turbine driven generator of claim 1, wherein the nozzle ring is separate from the generator end plate and shroud and includes locating protrusions received in detents in the generator end plate and the nozzle ring includes locating protrusions received in detents on the turbine shroud, the locating protrusions ensuring accurate alignment of the turbine shroud relative to an axis of rotation of the turbine wheel and shaft.

4. The turbine driven generator of claim 1, wherein the generator end plate, turbine wheel, nozzle ring, and turbine shroud form a turbine assembly removable from the turbine casing while remaining connected to each other and to the generator.

5. The turbine driven generator of claim 1, wherein the turbine shroud and turbine casing are each connected to the generator end plate and are not directly connected to each other.

6. The turbine driven generator of claim 1, wherein the nozzle ring is formed integrally with the generator end plate or shroud.

7. The turbine driven generator of claim 1, wherein the inlet of the turbine casing is permanently joined to a source of vapor phase working fluid and the outlet of the turbine casing is permanently joined to a conduit conducting turbine exhaust away from the turbine exhaust outlet, allowing the turbine driven generator to be separated from the turbine casing while the turbine casing remains permanently connected to the source of vapor phase working fluid and the conduit.

8. A method of manufacturing a Rankine cycle system incorporating the turbine driven generator of claim 1, comprising the steps of:
permanently connecting an outlet of an evaporator to the inlet of the turbine casing; and
permanently connecting an inlet of a condenser to the exhaust outlet of the turbine casing,
wherein the turbine casing and generator end plate are connected by removable fasteners, allowing the turbine driven generator to be separated from the turbine casing while the turbine casing remains permanently connected to the evaporator and condenser.

9. A turbo-generator comprising:
a generator having a shaft, a generator body and a generator first end plate having an inner surface secured to a first axial end of the generator body, said first end plate defining a central opening including a seal surrounding the shaft, the shaft extending along an axis of rotation through the first end plate and coupled to components of the generator to generate electrical current when the shaft is rotated;
a turbine wheel secured to the shaft adjacent an outer surface of said first end plate so the turbine wheel and shaft rotate together, said turbine wheel including a plurality of blades extending from a body of the turbine wheel to blade tips;
a nozzle ring including a plurality of vanes surrounding a periphery of the turbine wheel;
a turbine shroud secured to the first end plate with the nozzle ring between a periphery of the turbine shroud and the first end plate, said turbine shroud including a shroud inside surface defining a working clearance between the blade tips and the shroud, said shroud defining a turbine exhaust outlet surrounding an axis of rotation of the turbine wheel,
wherein said first end plate extends radially outward of a periphery of the shroud, the periphery of the shroud axially spaced from the outside surface of the first end plate to define a passage communicating with said vanes.

10. The turbo-generator of claim 9, comprising:
an annular shim between a base side of the nozzle ring and the outside surface of the first end plate, said annular shim determining the axial position of the shroud inside surface relative to the blade tips.

11. The turbo-generator of claim 9, wherein the nozzle ring is formed as an integral part of the first end plate or the shroud.

12. The turbo-generator of claim 9, comprising a second end plate secured to a second end of the generator body, said second end plate including a bearing supporting the generator shaft.

13. The turbo-generator of claim 12, wherein said generator body includes at least one bearing supporting the generator shaft between the second end plate and the first end plate.

14. The turbo-generator of claim 9, wherein said generator body includes at least one coolant flow channel for the circulation of coolant to remove heat from the generator.
